(19) United States
(12) Patent Application Publication
(10) Pub. No.: US 2022/0018389 A1
(43) Pub. Date: Jan. 20, 2022

(54) BEARING UNIT FOR MARBLE CUTTING MACHINES

(71) Applicant: Aktiebolaget SKF, Goteborg (SE)

(72) Inventors: Fausto Baracca, Massa (IT); Ettore Bertelloni, Massa (IT); Andrea A. Bertolini, Carrara (IT)

(21) Appl. No.: 17/377,958

(22) Filed: Jul. 16, 2021

(30) Foreign Application Priority Data
Jul. 20, 2020 (IT) 102020000017509

(51) Int. Cl. F16C 19/16; F16C 33/58

(52) U.S. Cl. CPC F16C 19/16; F16C 33/58

(57) ABSTRACT

Bearing unit suitable for a marble cutting machine having a radially outer ring rotatable about a central rotation axis (Y) of the bearing unit and provided with a radially inner raceway a stationary radially inner ring provided with a radially outer raceway, a row of rolling elements arranged between the radially outer ring and the radially inner ring, wherein the corresponding raceways allow rolling of the rolling elements and wherein the radially outer raceway of the radially inner ring is composed of two sections separated from each other and specular with respect to an axis (X) of symmetry of the bearing unit, having a radial direction.

### CROSS-REFERENCE RELATED APPLICATION

This application is based on and claims priority to Italian Patent Application No. 102020000017509 filed on Jul. 20, 2020, under 35 U.S.C. § 119, the disclosure of which is incorporated by reference herein.

### FIELD

The present invention relates to a bearing unit for marble cutting machines.

### BACKGROUND

Bearing units may be configured in configurations depending on their application. One known application of bearing units is in marble cutting devices.

### BRIEF DESCRIPTION OF THE DRAWINGS

The invention will now be described with reference to the accompanying drawings which illustrate a number of non-limiting examples of embodiment, in which:

FIG. 1 is a cross-section of an embodiment of a bearing unit for a marble cutting device.

FIG. 2 is a cross-section of an embodiment of a bearing unit for a marble cutting device.

FIG. 3 is a cross-sectioned view of an embodiment of a bearing unit for marble cutting machines in accordance with the present disclosure.

FIG. 4 is a view, on a larger scale, of a first detail of a bearing unit according to FIG. 3.

FIG. 5 is a view, on a larger scale, of a second detail of a bearing unit according to FIG. 3.

### DETAILED DESCRIPTION

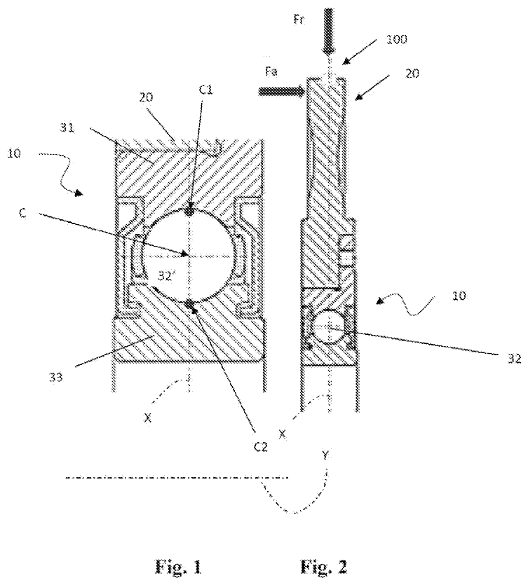

A bearing unit for marble cutting machines, such as that shown in FIGS. 1 and 2, have a rotation axis Y and may include a radially outer ring 31, rotatable about the rotation axis Y and provided with a radially inner raceway 310, a stationary radially inner ring 33, provided with a radially outer raceway 330, a row 32 of rolling elements 32′, e.g., balls, arranged between the rings 31 and 33 so as to roll inside the raceways 310 and 330.

During use of a bearing unit 10 in marble cutting machines, namely machines provided with several diamond-coated wires for cutting the marble, bearing unit 10 is connected to a pulley 20 coaxial with the axis Y and integral with radially outer ring 31 so as to drive, in a known manner, a respective diamond-coated wire 100 which performs cutting of the marble.

Typically each ball 32′ has a centre C of symmetry crossed in a radial direction by an axis X of symmetry of a bearing unit 10, transverse to the axis Y, and has two points of contact with rings 31 and 33 of bearing unit 10: a point C1 between each ball 32′ and outer ring 31 and a point C2 between each ball 32′ and inner ring 33. The two contact points C1 and C2 of each ball 32′ are aligned with the centre C of the associated ball 32′ along the associated axis X of symmetry.

The interaction between diamond-coated wire 100 and slab of marble (not shown) is such that the top part of the pulley 20 is subject to distributed forces, the resultant axial force Fa is directed parallel to the axis Y and the resultant radial force Fr is directed towards the axis Y and transversely with respect to the axis Y and is also typically axially offset with respect to the axis X of the bearing unit 10. The action of these forces produces a resultant moment on a bearing unit 10 which, in particular depending on the value of axial displacement of the resultant radial force Fr, may stress the bearing unit in a relatively severe manner. It is clear that an excessive value of the lever arm causes high contact pressures between the rings and balls which have an adverse effect on the duration of the working life of the bearing unit.

Moreover this problem influences the quality of cutting of the marble: the greater the value of the moment transmitted to the bearing unit, the less precise will be the cut in the slab of marble. In the (common) situation where machining is carried out on thin slabs with a thickness of about 2 mm, there is even the real risk of the slab of marble breaking.

In some applications, in order to improve the resistance to eccentric loads, bearing units are used in which an inner ring is formed by two specular half-rings. In such cases, however, axial dimensions of the bearing unit increase. This is problematic in the case of use in marble cutting machines where several bearings mounted axially in series with each other are provided.

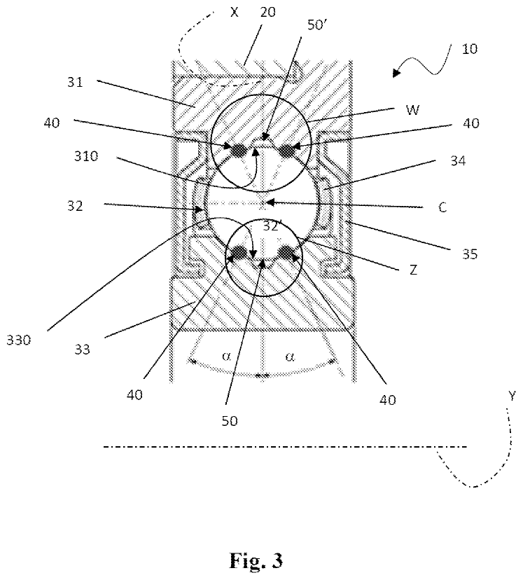

With reference to FIG. 3 and using the same reference numbers to indicate same or similar parts already described above with reference to FIGS. 1 and 2, 10 denotes in its entirety a bearing unit for marble cutting machines.

Bearing unit 10 includes a radially outer ring 31, rotatable about a central rotation axis Y of the bearing unit 10, a stationary radially inner ring 33, a row 32 of rolling elements 32′ (in this example balls, arranged between the radially outer ring 31 and the radially inner ring 33), and a cage 34 for containing the rolling bodies so as to keep the rolling elements of the row of rolling bodies 32 in position.

In the whole of this disclosure, including the claims, the terms and the expressions indicating positions and orientations such as “radial” and “axial” are understood as referring to the central axis of rotation Y of a bearing unit 10.

Radially outer ring 31 is provided with a radially inner raceway 310, while radially inner ring 33 is provided with a radially outer raceway 330 for allowing rolling of row 32 of rolling elements 32′ arranged between the radially outer ring 31 and radially inner ring 33. Some examples of embodiment and the associated drawings may envisage the use of rolling elements other than balls without thereby departing from the scope of the present invention.

A bearing unit 10 is also provided with sealing devices 35 for sealing off the bearing unit from the external environment. Such sealing means may be metallic sealing devices. In a bearing unit in accordance with this disclosure, a bearing unit, e.g., 10 has been designed in order to minimize the effects of moments transmitted by a marble cutting machine via a pulley, e.g., 20.

In particular, the radially outer raceway 330 of the radially inner ring 33 is composed of two sections 331, 322 separated from each other and specular with respect to an axis X of symmetry of the bearing unit 10, having a radial direction.

This characteristic feature is very advantageous in particular for use of a bearing unit 10 in marble cutting machines. In fact, since in marble cutting machines the bearings are mounted in series and very close together, in particular in the case of cuts performed on very thin marble slabs, by providing only one radially ring, but with two track sections separated from each other, it is possible not only to keep the axial dimensions of the bearing unit very small, but also to increase the resistance to the moments due to the eccentric radial forces caused by the action of the diamond-coated wires.

Advantageously, between the two sections 331, 332 of the radially outer raceway 330 of the radially inner ring 33 there is a radially inner circumferential groove 50 containing lubricating grease for keeping the radially outer raceway 330 lubricated.

The presence of the circumferential groove 50 is advantageous since, in order to form two sections 331, 332 of the raceway which are specular with each other on the radially inner ring 33, the tool which performs machining in any case requires a discharge groove in an intermediate position halfway along the ring. Otherwise a cusp or in any case a non-uniform point would be created between the two sections of the raceway, with the danger of generating a starting point for cracks. It is also advantageous if the necessary discharge groove is designed with suitable dimensions such that it is configured as a small reservoir for the lubricating grease, the presence of which is undoubtedly advantageous when used on marble cutting machines in view of the high cutting temperatures which arise during the cutting operations.

Preferably and for the reasons already discussed, the radially inner raceway 310 of the radially outer ring 31 may also be composed of two sections 311, 312 separated from each other and specular with respect to the axis X of symmetry of the bearing unit 10.

Advantageously, there may also be present between the two sections 311, 312 of the radially inner raceway 310 of the radially outer ring 31 a radially outer circumferential groove 50′ containing lubricating grease for keeping the radially inner raceway 310 lubricated.

Preferably and still with the aim of increasing the resistance to moments due to the eccentric radial forces, four contact points 40 are provided between the raceways 310, 330 and the rolling elements 32′, i.e. one contact point 40 for each section 311, 312, 331, 332 of the raceways 310, 330.

Advantageously, the four contact points 40 are symmetrical with respect to the axis X of symmetry of the bearing unit 10. In particular, an angle α which is formed with the axis X by the straight line joining each contact point 40 with the centre C of the rolling elements 32′ may be between 20° and 40°. In this way, as can be seen from the theoretical calculations based on experimental tests, the best result in terms of reduction of the effects associated with the resultant axial force Fa and the resultant radial force Fr transmitted from the marble cutting machine to the bearing unit 10 is obtained. Even more particularly, an optimum value of the angle α is 25°.

The dimensions of the circumferential grooves 50, 50′ must be optimized so that, on the one hand, they are large enough to contain a significant amount of lubricating grease and, on the other hand, are not so large that they excessively reduce the entire area of the raceways and in particular the contact zones in the vicinity of the contact points 40.

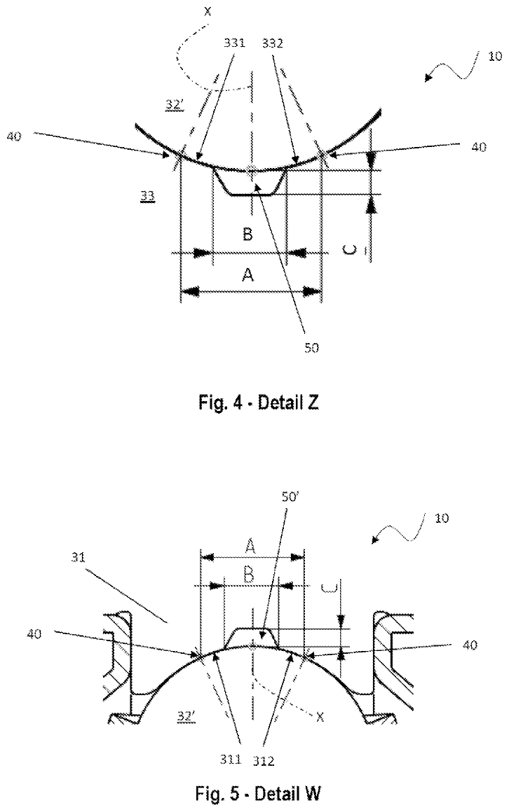

With reference to FIG. 4 and, in particular, with reference to the radially outer raceway 330 of the radially inner ring 33, the associated contact points 40, arranged on a same cylindrical surface coaxial with the axis Y, are axially spaced from each other by a given axial distance A, and the associated circumferential groove 50, which is axially positioned in a substantially intermediate position between the two associated contact points 40, has a width B advantageously of between 40% and 60% of the distance A and, even more preferably, may be equal to 50% of the same distance A.

The depth C, in the radial direction, of the circumferential groove 50 may instead be between 40% and 60% of the width B of the circumferential groove 50 and even more preferably may be equal to 50% of the same width B.

With reference to FIG. 5 and in particular with reference to the radially inner raceway 310 of the radially outer ring 31, the position and the dimensions of the circumferential groove 50′ are identical to that described in connection with the circumferential groove 50 of the radially outer raceway 330.

Basically, as a result of the techniques disclosed herein, the contact forces between rolling elements 32′ and raceways 310, 330 may be distributed at four contact points 40, i.e. one contact point for each section 311, 312, 331, 332 of the raceways. In this way it is possible to minimize the axial dimensions of the bearing unit since only one inner ring and not a pair of inner rings may be used. At the same time, owing to the presence of four contact points between the raceways and the rolling elements, it is possible to increase the resistance to the moments due to the eccentric radial forces caused by the action of the diamond-coated wires. In this way the duration of the bearing unit is increased and the quality of cutting of the marble sheets is improved.

Furthermore, the circumferential grooves 50, 50′ formed on each of raceways 330, 310, required for the aforementioned technological reasons, act advantageously as lubricating grease containers and this helps keep the said raceways properly lubricated.

The object of the present disclosure is to provide a bearing unit in which the contact between the rolling elements and raceways is optimized in order to overcome the aforementioned drawbacks associated with the presence of eccentric loads on the bearing unit.

The object of the present disclosure is to provide a bearing unit having the characteristic features described in the attached claims.

In addition to the embodiments in accordance with this disclosure, in the variants described above, it is to be understood that numerous further variants exist. It must also be understood that said embodiments are only examples and do not limit either the scope of the disclosed techniques and devices, nor its applications, nor its possible configurations. On the contrary, although the description provided above enables the person skilled in the art to implement embodiments in accordance with this disclosure, it must be understood that numerous variations of the components described are feasible, without thereby departing from the scope of the invention, as defined in the accompanying claims, interpreted literally and/or in accordance with their legal equivalents.

1. A bearing unit suitable for a marble cutting machine comprising:
a radially outer ring, rotatable about a central rotation axis (Y) of the bearing unit and provided with a radially inner raceway,
a stationary radially inner ring, provided with a radially outer raceway,
a row of rolling elements arranged between the radially outer ring and the radially inner ring, wherein the radially outer raceway of the radially inner ring is composed of two sections separated from each other by a groove, the two sections being specular with respect to an axis (X) of symmetry of the bearing unit.

2. The bearing unit of claim 1, wherein the groove is a radially inner circumferential groove containing lubricating grease.

3. The bearing unit of claim 1, wherein the radially inner raceway of the radially outer ring is composed of two sections separated from each other by a second groove and specular with respect to the axis (X).

4. The bearing unit of claim 3, wherein the second groove is a radially outer circumferential groove containing lubricating grease for keeping the radially inner raceway lubricated.

5. The bearing unit of claim 3, wherein the radially outer raceway and the radially inner raceway define four contact points with the rolling elements.

6. The bearing unit of claim 5, wherein the four contact points are symmetrical with respect to the axis (X).

7. The bearing unit of claim 6, wherein an angle (α) formed with the axis (X) by a straight line joining each contact point with a centre (C) of the rolling elements, is between 20° and 40°.

8. The bearing unit of claim 7, wherein a width (B) of the circumferential groove is between 40% and 60% of an axial distance (A) between a pair of contact points.

9. The bearing unit of claim 8, wherein a depth (C) in a radial direction of the circumferential groove is between 40% and 60% of the width (B) of the circumferential groove.

10. The bearing unit of claim 9, wherein the angle (α) is about 25 degrees.

11. A bearing unit suitable for a marble cutting machine comprising:
a radially outer ring, rotatable about a central rotation axis (Y) of the bearing unit and provided with a radially inner raceway,
a stationary radially inner ring, provided with a radially outer raceway,
a row of rolling elements arranged between the radially outer ring and the radially inner ring, wherein the radially outer raceway of the radially inner ring is composed of two sections separated from each other by a groove, the two sections being specular with respect to an axis (X) of symmetry of the bearing unit, wherein the groove is a radially inner circumferential groove containing lubricating grease, wherein the radially inner raceway of the radially outer ring is composed of two sections separated from each other by a second groove and specular with respect to the axis (X), wherein the radially outer raceway and the radially inner raceway define four contact points with the rolling elements, wherein an angle (α) formed with the axis (X) by a straight line joining each contact point with a centre (C) of the rolling elements, is between 20° and 40°.

12. A bearing unit suitable for a marble cutting machine comprising:
a radially outer ring, rotatable about a central rotation axis (Y) of the bearing unit and provided with a radially inner raceway,
a stationary radially inner ring, provided with a radially outer raceway,
a row of rolling elements arranged between the radially outer ring and the radially inner ring, wherein the radially outer raceway of the radially inner ring is composed of two sections separated from each other by a groove, the two sections being specular with respect to an axis (X) of symmetry of the bearing unit, wherein the groove is a radially inner circumferential groove containing lubricating grease, wherein the radially inner raceway of the radially outer ring is composed of two sections separated from each other by a second groove and specular with respect to the axis (X), wherein a width (B) of the radially inner circumferential groove is between 40% and 60% of an axial distance (A) between a pair of contact points.
